(19) United States
(12) Patent Application Publication
(10) Pub. No.: US 2014/0072743 A1
(43) Pub. Date: Mar. 13, 2014

(54) POLYMER FILMS CONTAINING MICROSPHERES

(71) Applicants: Vincent Stephenne, Sart-Dames-Avelines (BE); Patrick Balteau, Evelette (BE); Jean-Claude Bonte, Lessines (BE); Arnaud Jaspard, Havre (BE); Jean-Michel Vallée, Horrues (BE)

(72) Inventors: Vincent Stephenne, Sart-Dames-Avelines (BE); Patrick Balteau, Evelette (BE); Jean-Claude Bonte, Lessines (BE); Arnaud Jaspard, Havre (BE); Jean-Michel Vallée, Horrues (BE)

(73) Assignees: Baxter Healthcare S.A., Glattpark (Opfikon) (CH); Baxter International Inc., Deerfield, IL (US)

(21) Appl. No.: 13/609,799

(22) Filed: Sep. 11, 2012

(51) Int. Cl. C08L 23/12; C08K 7/28; B32B 5/16; B32B 1/02; B29C 47/00; B31B 1/00; C08K 3/36; B32B 17/10; B82Y 30/00

(52) U.S. Cl. 428/36.4; 523/218; 523/219; 428/323; 428/313.9; 264/177.2; 493/51; 977/773

(57) ABSTRACT

Polymer films having hollow microspheres to simultaneously reduce the coefficient of friction and residue on ignition, and methods of making films and containers from the films. In a general embodiment, the present disclosure provides a film including at least one layer having hollow microspheres mixed within the layer. The microspheres can be in a concentration ranging from about 250 ppm to about 750 ppm within the layer.

### BACKGROUND

The present disclosure relates generally to polymer films. More particularly, the present disclosure relates to polymer films having improved slip/anti-blocking properties and low residue on ignition.

Multilayer films are widely used throughout a variety of industries, for example, including use in containers for food or medical solution packaging. One of the desired properties of a multilayer extruded in film is its toughness or ability to resist damage in use or transport. Another desired property is the ability to make both a peel seal at the desired strength to suit the application as well as a permanent seal to permanently enclose a container. An additional desired property is to provide a barrier to gases such as oxygen, carbon dioxide or water vapor in order to maintain the stability of contained solutions.

Conventional multilayer films can be made from polyolefin resins that have high coefficients of friction that make them difficult to manipulate during the manufacturing process. Slip agents overcome the polyolefin resins' natural tackiness so they can move smoothly through converting and packaging equipment. Silica is currently used as a slip or anti-blocking agent in the layers of plastic films. However, the presence of silica may lead to residue on ignition that is above pharmacopoeia limits of various countries including Japan, Korea and China.

### SUMMARY

The present disclosure relates to polymer films having microspheres and methods of making the films and containers made from the films. In a general embodiment, the present disclosure provides a film including one or more layers having hollow microspheres or “bubbles” mixed within the layer. For example, the microspheres can be mixed approximately evenly throughout any one or more portions of the layer. The microspheres can be in a concentration ranging from about 250 ppm to about 3000 ppm within the layer.

In an embodiment, the microspheres are made from soda lime borosilicate glass. The microspheres can have a diameter ranging from about 10 μm to about 300 μm. The microspheres can further have a density ranging from about 0.1 g/cc to about 1.2 g/cc.

In an embodiment, the film layer having the microspheres further includes silica mixed within the layer. The silica can be in a concentration ranging from about 1000 ppm to about 2000 ppm within the layer.

In another embodiment, the present disclosure provides a multi-layered film including a skin layer, a barrier layer and a peel seal layer. The skin layer and the peel seal layer are attached to the core layer on opposing sides of the barrier layer. At least one of the skin layer and the peel seal layer includes hollow glass microspheres mixed within the layer.

In an embodiment, the skin layer includes a component such as polypropylene random copolymers, polypropylene homopolymers, nylon, styrene-ethylene-butylene-styrene block copolymer, copolyester ether block copolymers or a combination thereof. The barrier layer can include a component such as polyamide 6, polyamide 6,6/6,10 copolymer, amorphous polyamides or a combination thereof.

In an embodiment, the peel seal layer includes a material such as a homophase polymer, a matrix-phase polymer or a combination thereof. For example, the peel seal layer can include a blend of a polypropylene with a styrene-ethylene-butylene-styrene block copolymer. In a further example, the peel seal layer may include another polyolefin with a different melting point such as a second polypropylene or a linear low-density polyethylene.

In an embodiment, the film includes one or more tie layers that attach at least one of the skin layer and the peel seal layer to the barrier layer. The tie layer can include a component such as maleated linear low-density polyethylene, maleated polypropylene homopolymers, maleated polypropylene copolymers or a combination thereof.

In an embodiment, a core layer is positioned between the barrier layer and at least one of the skin layer and the peel seal layer. The core layer can include a component such as polypropylene homopolymers, propylene-ethylene random copolymers, syndiotactic propylene-ethylene copolymers, polypropylene elastomers, propylene based elastomers, ethylene based elastomers, styrene-ethylene-butylene-styrene block copolymers, ethylene-propylene rubber modified polypropylenes or a combination thereof.

In an alternative embodiment, the present disclosure provides a multiple chamber container including a body defined by a film. The body includes at least two chambers separated by a peelable seal with the film including at least one layer having microspheres mixed within the layer.

In yet another embodiment, the present disclosure provides a container including a first sidewall and a second sidewall sealed together along at least one common peripheral edge to define a fluid chamber. The first and/or second sidewall includes a multilayer film including a skin layer, a first tie layer, a barrier layer disposed adjacent the first tie layer, a second tie layer disposed adjacent the barrier layer, a core layer, and a seal layer. The skin layer and/or the seal layer includes glass microspheres mixed within the layer.

In still another embodiment, the present disclosure provides a method of making a film. The method comprises mixing microspheres throughout one or more polymers. For example, the microspheres can be approximately evenly dispersed through the polymer. The method further comprises extruding the polymer into a film. The film can subsequently be formed into container.

An advantage of the present disclosure is to provide films having improved slip properties.

Another advantage of the present disclosure is to provide films having improved anti-blocking properties.

Yet another advantage of the present disclosure is to provide an improved film having an acceptably low residue on ignition.

Still another advantage of the present disclosure is to provide an improved method of making a container.

Additional features and advantages are described herein, and will be apparent from the following Detailed Description and the figures.

### BRIEF DESCRIPTION OF THE FIGURES

FIG. 1 is a cross-sectional view of a monolayer film in an embodiment of the present disclosure.

FIG. 2 is a cross-sectional view of a five-layer film in an embodiment of the present disclosure.

FIG. 3 is a cross-sectional view of a six-layer film in an embodiment of the present disclosure.

FIG. 4 is a view of a container fabricated from a film in an embodiment of the present disclosure.

FIG. 5 is a view of a multiple chamber container fabricated from a film in an embodiment of the present disclosure.

### DETAILED DESCRIPTION

The present disclosure relates to polymer films having microspheres and methods of making the films and containers made from the films. In a general embodiment, the present disclosure provides a film including at least one layer having hollow microspheres mixed within the layer. The present disclosure provides monolayer films as well as multilayer films useful for packaging applications. The films in embodiments of the present disclosure have improved slip and anti/blocking properties while maintaining toughness and/or peel seal capabilities.

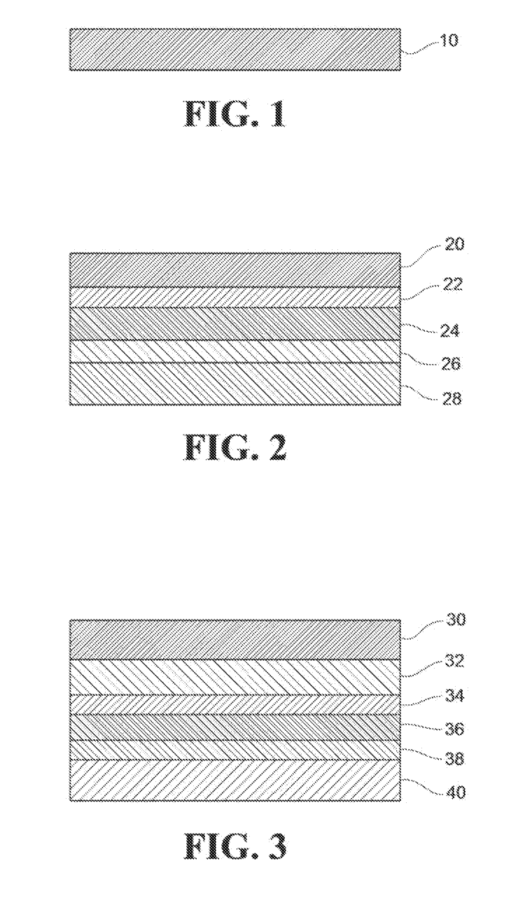

In a general embodiment illustrated in FIG. 1, the present disclosure provides a film 10 including a layer having microspheres mixed within the layer. The microspheres can be distributed evenly throughout any one or more portions of the layer. The microspheres can be added/mixed within the layer of film 10 using any suitable technology such as, for example, extrusion technology. It will be appreciated that the microspheres may be distributed through only a selected portion of an otherwise homogeneous layer by extruding the film with consecutive sublayers of the same material, one of such sublayers containing microspheres and one or more sublayers without any microspheres.

The layer can include microspheres in any suitable amount. For example, the microspheres can be at a concentration ranging from about 250 ppm to about 3000 ppm in the layer, for example about 250 ppm to about 700 ppm, about 350 ppm to about 650 ppm, about 400 ppm to about 600 ppm or about 450 ppm to about 550 ppm. Examples for individual values of the microsphere concentration are about 250 ppm, 300 ppm, 350 ppm, 400 ppm, 450 ppm, 500 ppm, 550 ppm, 600 ppm, 650 ppm, 700 ppm, 750 ppm, 1000 ppm, 2000 ppm, 3000 ppm and the like.

In another embodiment, the layer having the microspheres further includes silica mixed within the layer. For example, the silica can be amorphous synthetic silica having a cubic shape. The silica can have a density ranging from about 2.2 g/cc to about 2.3 g/cc. The silica can also have an average diameter of about 4 μm to about 5 μm.

The silica can be in any suitable amount in the layer. For example, the silica can be at a concentration ranging from 1000 ppm to about 2000 ppm within the layer such as about 1100 ppm to about 1900 ppm, about 1200 ppm to about 1800 ppm, about 1300 ppm to about 1700 ppm or about 1400 ppm to about 1600 ppm. Examples for individual values of silica concentration are about 1000 ppm, 1100 ppm, 1300 ppm, 1400 ppm, 1500 ppm, 1600 ppm, 1700 ppm, 1800 ppm, 1900 ppm, 2000 ppm and the like.

It is to be understood that the individual microspheres concentration values and the individual values for the silica concentration can also be the definition of the limit of a range. For example, the disclosure of concentrations of 300 ppm and 450 ppm is also to be regarded as the disclosure of the range from 300 ppm to 450 ppm. The same applies to any combination of specifically mentioned values through the present disclosure.

In an embodiment, the microspheres are hollow. The microspheres can be made from soda lime borosilicate glass. The microspheres can also be made from ceramic. Suitable examples of microspheres include iM30K (18 micron mean diameter, density 0.60 g/cc, crush strength 28000 psi) and K46 (40 micron median diameter, density 0.46 g/cc, crush strength 6000 psi) microspheres from 3M. The microspheres can have any suitable average diameter or width. For example, the average diameter of the microspheres can range from about 10 μm to about 300 μm, for example about 50 μm to about 250 μm, or about 100 μm to about 200 μm. Examples for individual values of the average diameter of the microspheres are about 10 μm, 25 μm, 50 μm, 75 μm, 100 μm, 125 μm, 150 μm, 175 μm, 200 μm, 225 μm, 250 μm, 275 μm, 300 μm and the like. In addition, microspheres of varying diameters can be blended in the layer.

The microspheres can also have any suitable density. For example, the microspheres can have a particle density ranging from about 0.1 g/cc to about 1.2 g/cc, for example about 0.2 g/cc to about 1.10 g/cc, about 0.3 g/cc to about 0.9 g/cc, about 0.4 g/cc to about 0.8 g/cc or about 0.5 g/cc to about 0.7 g/cc. Examples for individual values of the density of the microspheres are about 0.1 g/cc, 0.15 g/cc, 0.2 g/cc, 0.25 g/cc, 0.3 g/cc, 0.35 g/cc, 0.4 g/cc, 0.45 g/cc, 0.5 g/cc, 0.55 g/cc, 0.6 g/cc, 0.65 g/cc, 0.7 g/cc, 0.75 g/cc, 0.8 g/cc, 0.85 g/cc, 0.9 g/cc, 0.95 g/cc, 1 g/cc, 1.05 g/cc, 1.1 g/cc, 1.15 g/cc, 1.2 g/cc and the like.

In another embodiment, the layer having the microspheres further includes a nanomaterial mixed within the layer. The nanomaterials can be, for example, nanotubes and nanoclays. Nanomaterials according to embodiments of the present disclosure comprise particles having a size markedly lower than the common size of current ground mineral equivalents used in polymer films, which are usually of the order of several microns. According to an embodiment of the present disclosure, the nanomaterials have an average size ranging from about 10 to about 500 nanometers.

In another embodiment (illustrated in FIG. 2), the present disclosure provides a five-layer film having a skin layer 20, a barrier layer 24 and a peel seal layer 28. Skin layer 20 and/or peel seal layer 28 can include any suitable amount of microspheres dispersed within the layer. Skin layer 20 and peel seal layer 28 can be directly or indirectly attached to barrier layer 24 on opposing sides of barrier layer 24.

Skin layer 20, barrier layer 24 and peel seal layer 28 can each independently have any suitable thickness. For instance, skin layer 20 can have a thickness ranging from about 25 μm to about 75 μm. For instance, barrier layer 24 can have a thickness ranging from about 10 μm to about 50 μm. Peel seal layer 28 can have a thickness ranging from about 50 μm to about 150 μm.

The concentration of the microspheres in each layer can vary and may depend on the specific layer. For example, skin layer 20 can be less than about 25 μm thick and have a microspheres concentration ranging from about 1000 ppm to about 2000 ppm.

Skin layer 20 can contain a random copolymer polypropylene, homo-polymer polypropylene, nylon, styrene-ethylene-butylene-styrene block copolymer, a polyester, a copolyester ether, or a combination thereof. Barrier layer 24 can contain one or more polyamides (“PA”) (nylon), for example polyamide 6, polyamide 6,6/6,10 copolymer, amorphous polyamide, or a combination thereof. Alternatively, barrier layer 24 may contain other barrier materials such as ethylene vinyl alcohol copolymer (“EVOH”). An EVOH barrier layer is particularly suitable for applications in which the container will not be subjected to moist heat sterilization. In an embodiment, the film may contain an EVOH layer sandwiched between layers of polyamide.

Suitable polypropylene random copolymers include those sold by Flint Hills Resources under the HUNTSMAN trade name, by Borealis under the BORMED OR BORPURE trade names, and by TOTAL under the PPM trade name. Suitable polypropylene homopolymers include those sold by Flint Hills Resources under the HUNTSMAN® trade name. Suitable nylons include those sold by EMS under the GRIVORY® and GRILON® trade names. Suitable styrene-ethylene-butylene-styrene block copolymers include those sold by Kraton Polymers under the KRATON trade name.

Seal layer 28 can be a homophase polymer or a matrix-phase polymer system. Suitable homophase polymers include polyolefins and more preferably polypropylene and most preferably a propylene and ethylene copolymer as described in EP 0875231, which is incorporated herein by reference.

Suitable matrix-phase polymer systems will have at least two components. The two components can be blended together or can be produced in a two-stage reactor process. Typically, the two components will have different melting points. In the case where one of the components is amorphous, its glass transition temperature will be lower than the melting point of the other components. An example of a suitable matrix-phase polymer system includes a component of a homopolymer or copolymer of a polyolefin and a second component of a styrene and hydrocarbon copolymer. Another suitable matrix-phase system includes blends of polyolefins such as polypropylene with polyethylene, or polypropylene with a high isotactic index (crystalline) with polypropylene with a lower isotactic index (amorphous), or a polypropylene homopolymer with a propylene and α-olefin copolymer. Nonlimiting examples of suitable matrix-phase polymer systems are described in U.S. Pat. No. 7,678,097.

Suitable polyolefins include homopolymers and copolymers obtained by polymerizing alphα-olefins containing from 2 to 20 carbon atoms, and more preferably from 2 to 10 carbons. Therefore, suitable polyolefins include polymers and copolymers of propylene, ethylene, butene-1, pentene-1, 4-methyl-1-pentene, hexene-1, heptene-1, octene-1, nonene-1 and decene-1. Most preferably the polyolefin is a homopolymer or copolymer of propylene or a homopolymer or copolymer of polyethylene.

Suitable homopolymers of polypropylene can have a stereochemistry of amorphous, isotactic, syndiotactic, atactic, hemiisotactic or stereoblock. In a more preferred form of the present disclosure, the polypropylene will have a low heat of fusion from about 20 joules/gram to about 220 joules/gram, more preferably from about 60 joules/gram to about 160 joules/gram and most preferably from about 80 joules/gram to about 130 joules/gram. It is also desirable, in a preferred form of the present disclosure, for the polypropylene homopolymer to have a melting point temperature of less than about 165° C. and more preferably from about 130° C. to about 160° C., most preferably from about 140° C. to about 150° C. In one preferred form of the present disclosure, the homopolymer of polypropylene is obtained using a single site catalyst.

Suitable copolymers of propylene are obtained by polymerizing a propylene monomer with an α-olefin having from 2 to 20 carbons. In a more preferred form of the present disclosure, the propylene is copolymerized with ethylene in an amount by weight from about 1% to about 20%, more preferably from about 1% to about 10% and most preferably from 2% to about 5% by weight of the copolymer. The propylene and ethylene copolymers may be random or block copolymers.

It is also possible to use a blend of polypropylene and α-olefin copolymers wherein the propylene copolymers can vary by the number of carbons in the α-olefin. For example, the present disclosure contemplates blends of propylene and α-olefin copolymers wherein one copolymer has a 2 carbon α-olefin and another copolymer has a 4 carbon α-olefin. It is also possible to use any combination of α-olefins from 2 to 20 carbons and more preferably from 2 to 8 carbons. Accordingly, the present disclosure contemplates blends of propylene and α-olefin copolymers wherein a first and second α-olefins have the following combination of carbon numbers: 2 and 6, 2 and 8, 4 and 6, 4 and 8. It is also contemplated using more than 2 polypropylene and α-olefin copolymers in the blend. Suitable polymers can be obtained using a catalloy procedure. Suitable homopolymers of ethylene include those having a density of greater than 0.915 g/cc and includes low density polyethylene (“LDPE”), medium density polyethylene (“MDPE”) and high density polyethylene (“HDPE”).

Suitable copolymers of ethylene are obtained by polymerizing ethylene monomers with an α-olefin having from 3 to 20 carbons, more preferably 3-10 carbons and most preferably from 4 to 8 carbons. It is also desirable for the copolymers of ethylene to have a density as measured by ASTM D-792 of less than about 0.915 g/cc and more preferably less than about 0.910 g/cc and even more preferably less than about 0.900 g/cc. Such polymers are oftentimes referred to as VLDPE (very low density polyethylene) or ULDPE (ultra low density polyethylene). Preferably the ethylene α-olefin copolymers are produced using a single site catalyst and even more preferably a metallocene catalyst system. Single site catalysts are believed to have a single, sterically and electronically equivalent catalyst position as opposed to the Ziegler-Natta type catalysts which are known to have a mixture of catalysts sites. Such single-site catalyzed ethylene α-olefins are sold by Dow under the trade name AFFINITY®, DuPont Dow under the trademark ENGAGE® and by Exxon under the trade name EXACT®. These copolymers shall sometimes be referred to herein as m-ULDPE.

Suitable copolymers of ethylene also include ethylene and lower alkyl acrylate copolymers, ethylene and lower alkyl substituted alkyl acrylate copolymers and ethylene vinyl acetate copolymers having a vinyl acetate content of from about 8% to about 40% by weight of the copolymer. The term “lower alkyl acrylates” refers to comonomers having the formula set forth in Diagram 1:

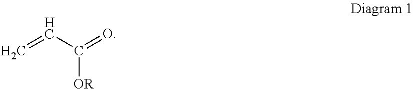

The R group refers to alkyls having from 1 to 17 carbons. Thus, the term “lower alkyl acrylates” includes but is not limited to methyl acrylate, ethyl acrylate, butyl acrylate and the like.

The term “alkyl substituted alkyl acrylates” refers to comonomers having the formula set forth in Diagram 2:

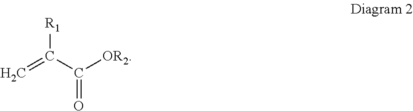

R₁ and R₂ are alkyls having 1-17 carbons and can have the same number of carbons or have a different number of carbons. Thus, the term “alkyl substituted alkyl acrylates” includes but is not limited to methyl methacrylate, ethyl methacrylate, methyl ethacrylate, ethyl ethacrylate, butyl methacrylate, butyl ethacrylate and the like.

Suitable polybutadienes include the 1,2- and 1,4-addition products of 1,3-butadiene (these shall collectively be referred to as polybutadienes). In a more preferred form of the present disclosure, the polymer is a 1,2-addition product of 1,3 butadiene (these shall be referred to as 1,2 polybutadienes). In an even more preferred form of the present disclosure, the polymer of interest is a syndiotactic 1,2-polybutadiene and even more preferably a low crystallinity, syndiotactic 1,2 polybutadiene. In a preferred form of the present disclosure, the low crystallinity, syndiotactic 1,2 polybutadiene will have a crystallinity less than 50%, more preferably less than about 45%, even more preferably less than about 40%, even more preferably the crystallinity will be from about 13% to about 40%, and most preferably from about 15% to about 30%. In a preferred form of the present disclosure, the low crystallinity, syndiotactic 1,2 polybutadiene will have a melting point temperature measured in accordance with ASTM D 3418 from about 70° C. to about 120° C. Suitable resins include those sold by JSR (Japan Synthetic Rubber) under the grade designations: JSR RB 810, JSR RB 820, and JSR RB 830.

Suitable polyesters include polycondensation products of di- or polycarboxylic acids and di or poly hydroxy alcohols or alkylene oxides. In a preferred form of the present disclosure, the polyester is a polyester ether. Suitable polyester ethers are obtained from reacting 1,4-cyclohexane dimethanol, 1,4-cyclohexane dicarboxylic acid and polytetramethylene glycol ether and shall be referred to generally as PCCE. Suitable PCCE's are sold by Eastman under the trade name ECDEL. Suitable polyesters farther include polyester elastomers which are block copolymers of a hard crystalline segment of polybutylene terephthalate and a second segment of a soft (amorphous) polyether glycols. Such polyester elastomers are sold by Du Pont Chemical Company under the trade name HYTREL®.

Suitable polyamides include those that result from a ring-opening reaction of lactams having from 4-12 carbons. This group of polyamides therefore includes nylon 6, nylon 10 and nylon 12. Acceptable polyamides also include aliphatic polyamides resulting from the condensation reaction of di-amines having a carbon number within a range of 2 to 13, aliphatic polyamides resulting from a condensation reaction of di-acids having a carbon number within a range of 2 to 13, polyamides resulting from the condensation reaction of dimer fatty acids, and amide containing copolymers. Thus, suitable aliphatic polyamides include, for example, nylon 66, nylon 6,10 and dimer fatty acid polyamides.

Suitable styrene and hydrocarbon copolymers include styrene and the various substituted styrenes including alkyl substituted styrene and halogen substituted styrene. The alkyl group can contain from 1 to about 6 carbon atoms. Specific examples of substituted styrenes include alpha-methylstyrene, beta-methylstyrene, vinyltoluene, 3-methylstyrene, 4-methylstyrene, 4-isopropylstyrene, 2,4-dimethylstyrene, o-chlorostyrene, p-chlorostyrene, o-bromostyrene, 2-chloro-4-methylstyrene, etc. Styrene is the most preferred.

The hydrocarbon portion of the styrene and hydrocarbon copolymer includes conjugated dienes. Conjugated dienes which may be utilized are those containing from 4 to about 10 carbon atoms and more generally, from 4 to 6 carbon atoms. Examples include 1,3-butadiene, 2-methyl-1,3 -butadiene(isoprene), 2,3 -dimethyl-1,3 -butadiene, chloroprene, 1,3 -pentadiene, 1,3-hexadiene, etc. Mixtures of these conjugated dienes also may be used such as mixtures of butadiene and isoprene. The preferred conjugated dienes are isoprene and 1,3-butadiene.

The styrene and hydrocarbon copolymers can be block copolymers including di-block, tri-block, multi-block, and star block. Specific examples of diblock copolymers include styrene-butadiene, styrene-isoprene, and the hydrogenated derivatives thereof. Examples of triblock polymers include styrene-butadiene-styrene, styrene-isoprene-styrene, alpha-methylstyrene-butadiene-alpha-methylstyrene, and alpha-methylstyrene-isoprene-alpha-methylstyrene and hydrogenated derivatives thereof.

The selective hydrogenation of the above block copolymers may be carried out by a variety of well known processes including hydrogenation in the presence of such catalysts as Raney nickel, noble metals such as platinum, palladium, etc., and soluble transition metal catalysts. Suitable hydrogenation processes which can be used are those wherein the diene-containing polymer or copolymer is dissolved in an inert hydrocarbon diluent such as cyclohexane and hydrogenated by reaction with hydrogen in the presence of a soluble hydrogenation catalyst. Such procedures are described in U.S. Pat. Nos. 3,113,986 and 4,226,952, the disclosures of which are incorporated herein by reference.

Particularly useful hydrogenated block copolymers are the hydrogenated block copolymers of styrene-isoprene-styrene, such as a styrene-(ethylene/propylene)-styrene block polymer. When a polystyrene-polybutadiene-polystyrene block copolymer is hydrogenated, the resulting product resembles a regular copolymer block of ethylene and 1-butene (“EB”). As noted above, when the conjugated diene employed is isoprene, the resulting hydrogenated product resembles a regular copolymer block of ethylene and propylene (“EP”). One example of a commercially available selectively hydrogenated copolymer is KRATON® G-1652 which is a hydrogenated SBS triblock including 30% styrene end blocks and a midblock equivalent is a copolymer of ethylene and 1-butene. This hydrogenated block copolymer is often referred to as SEBS. Other suitable SEBS or SIS copolymers are sold by Kurrarry under the tradename SEPTON® and HYBRAR®. It may also be desirable to use graft modified styrene and hydrocarbon block copolymers by grafting an alpha, beta-unsaturated monocarboxylic or dicarboxylic acid reagent onto the selectively hydrogenated block copolymers described above.

The block copolymers of the conjugated diene and the vinyl aromatic compound are grafted with an alpha, beta-unsaturated monocarboxylic or dicarboxylic acid reagent. The carboxylic acid reagents include carboxylic acids per se and their functional derivatives such as anhydrides, imides, metal salts, esters, etc., which are capable of being grafted onto the selectively hydrogenated block copolymer. The grafted polymer will usually contain from about 0.1 to about 20%, and preferably from about 0.1 to about 10% by weight based on the total weight of the block copolymer and the carboxylic acid reagent of the grafted carboxylic acid. Specific examples of useful monobasic carboxylic acids include acrylic acid, methacrylic acid, cinnamic acid, crotonic acid, acrylic anhydride, sodium acrylate, calcium acrylate and magnesium acrylate, etc. Examples of dicarboxylic acids and useful derivatives thereof include maleic acid, maleic anhydride, fumaric acid, mesaconic acid, itaconic acid, citraconic acid, itaconic anhydride, citraconic anhydride, monomethyl maleate, monosodium maleate, etc. The styrene and hydrocarbon block copolymer can be modified with an oil such as the oil modified SEBS sold by the Shell Chemical Company under the product designation KRATON® G2705.

As further shown in FIG. 2, the multilayer film can include one or more tie layers 22 and 26 that are used to attach skin layer 20 and/or seal layer 28 to barrier layer 24. Tie layers 22 and 26 can contain any suitable adhesive material such as, for example, maleated LLDPE, maleated polypropylene homopolymer, maleated polypropylene copolymer, maleated polypropylene based TPO or a combination thereof.

In an alternative embodiment illustrated in FIG. 3, the present disclosure provides a film including a skin layer 30, a barrier layer 36 and a seal layer 40. Skin layer 30 and seal layer 40 can be attached to barrier layer 36 on opposing sides of barrier layer 36. Skin layer 30 can contain polypropylene homo-polymer, polypropylene random copolymer, polypropylene based TPO, polyamide (nylon), styrene-ethylene-butylene-styrene block copolymer, copolyester ether block copolymer or a combination thereof.

As further shown in FIG. 3, the film can further include a core layer 32 positioned between skin layer 30 and barrier layer 36. Core layer 32 can contain propylene-ethylene random copolymer, syndiotactic propylene-ethylene copolymer, polypropylene elastomer, polypropylene homopolymer, propylene based elastomer, ethylene based elastomer, styrene-ethylene-butylene-styrene block copolymer, ethylene-propylene rubber modified polypropylene or a combination thereof. Suitable propylene-ethylene copolymers include those sold by Exxon under the VISTAMAXX tradename, by Dow under the VERSIFY tradename, by Total under the ATOFINA tradename and by Basell under the PROFAX tradename. The film can further include one or more tie layers 34 and 38 that attach skin layer 30, peel seal layer 40, barrier layer 36 and/or core layer 34 to each other.

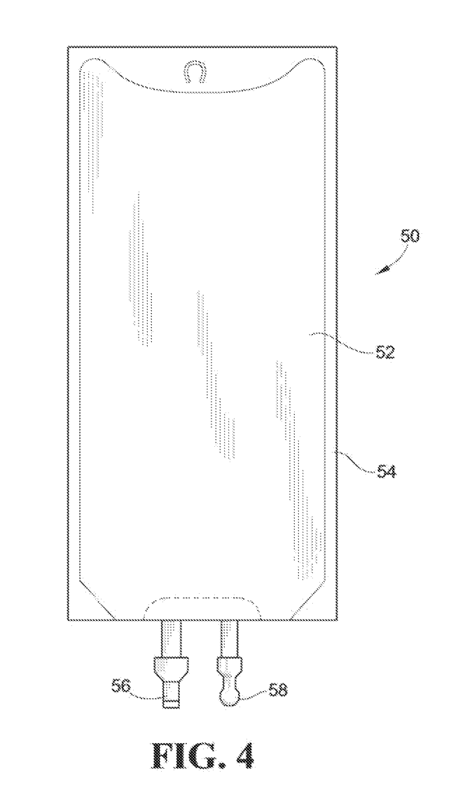

The films in embodiments of the present disclosure can be used to make any suitable containers, for example, used to hold a substance such as a pharmaceutical or a medical compound or solution. In an embodiment shown in FIG. 4, the present disclosure provides a container 50 including a first sidewall 52 and a second sidewall (not shown) opposite the first sidewall sealed together along a peripheral seam 54 to define a fluid chamber. Container 50 can include one or more port tubes 56 and 58 that are used to fill and empty the contents of container 50.

Any one or more of the sidewalls of container 50 can be fabricated from one of the monolayer or multiple layered films set forth above. It will also be appreciated that container 50 may be formed from an extruded tubular film sealed at its open ends. In this case, peripheral seam 54 may consist of two seams on opposing ends of the tube. Container 50 may be configured such that the seams are at the top and bottom of the container or along its vertical sides.

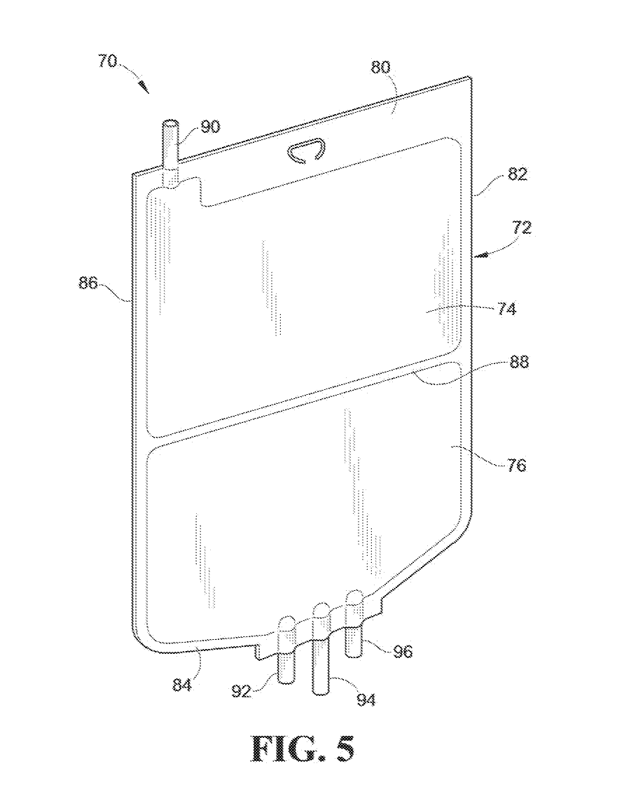

In an alternative embodiment shown in FIG. 5, the present disclosure provides a multiple chamber container 70 including a body 72 defined by a film. Multiple chamber container 70 includes two chambers 74 and 76. It should be appreciated that in alternative embodiments more than two chambers can be provided in the container. Chambers 74 and 76 are designed for the separate storage of substances and/or solutions.

In the illustrated embodiment, any portion of container 70 is made from a film including one or more layers having microspheres mixed within the layer as previously described in detail. Container 70 may be made from two sheets of the film that are, for example, heat sealed along their edges to form permanent seals. In the illustrated embodiment, two sheets of film are used. The sheets are sealed about the periphery of container 70 at edges 80, 82, 84, and 86. A peelable seal 88 is provided between the sheets of film to form chambers 74 and 76. Of course, if additional chambers are provided, additional peelable seals can be provided.

Container 70 and peelable seal 88 can be constructed from films having a peel seal layer in accordance with embodiments of the present disclosure. The peel seal layer can allow both a peelable and permanent seal to be created. Thus, the permanent side seals 80, 82, 84, and 86 as well as peelable seal 88 can be created from the same layer of film.

As further illustrated in FIG. 5, container 70 can further include one or more ports 90, 92, 94 and 96. Ports 90, 92, 94 and 96 provide communication with the interior of chambers 74 and 76, but could be located at any appropriate locations on container 70. These ports allow fluid to be added to or removed from chambers 74 and 76. Ports 90, 92, 94 and 96 can also include a membrane (not shown) that is pierced by, for example, the cannula or spike of an administration set.

It should be appreciated that one or more of the ports may be provided in the form of a molded structure with a surface specially adapted for sealing to the container, either between the sheets (in which case the port structure is sometimes referred to as a “gondola”) or directly to the wall. It should also be appreciated that the ports may include valves or similar closure structures rather than a simple membrane. Examples of such alternative port structures include the medication port depicted in U.S. Pat. No. 6,994,699 and the various access ports depicted in U.S. Patent Publication No. 2005/0083132, each of which is incorporated herein by reference.

Depending on the methods employed to manufacture the containers, fill ports may not be necessary at all. For example, if the containers are to be manufactured from a continuous roll of plastic film, the film could be folded lengthwise, a first permanent seal created, the first compartment filled with solution, then a peelable seal created, a second compartment filled, a permanent seal created, and so on.

### EXAMPLES

By way of example and not limitation, the following examples are illustrative of various embodiments of the present disclosure.

### Example 1

Silica as a film additive was augmented or replaced by glass (hollow) microspheres in order to reduce residue on ignition while keeping excellent slip/anti-blocking properties of a film. Several properties of the film having the glass microspheres were compared with the film having only silica as a slip agent. Characteristics of the microspheres and the silica are shown in Table 1.

TABLE 1

| | iM30K | | Silica (Borealis data) | |
|---|---|---|---|---|
| Composition | soda-lime borosilicate | | amorphous synthetic silica | |
| Shape | Glass hollow spheres with | | cubic | |
| | thin walls | | | |
| True density | 0.60 | g/cc | 2.2-2.3 | μm |
| Average | 18 | μm | 4-5 | μm |
| diameter | | | | |

Different compounds and films containing 500 ppm of 3M iM30K glass microspheres (instead of 1800 ppm of silica) were extruded and characterized.

Compounds Description:
Compound 1A=Polypropylene (“PP”) (Borealis RE906CF)+500 ppm 3M iM30K glass microspheres
Compound 1B=Polypropylene (Borealis RE216CF) containing 1800 ppm of silica
Compound 2A=Polypropylene (Borealis RE906CF) +500 ppm 3M iM30K glass microspheres in the peel seal
Compound 2B=Wittenburg Cawiton PR4851A ternary compound

Residue on ignition (“RoI”) results in wt % (according to the Korean Pharmacopoeia method, 8^{th} version):
Compound 1A: 0.08%
Compound 1B: 0.25%
Compound 2A: 0.06%
Compound 2B: 0.14%

Films

TABLE 2
Films description (cast extrusion)

| Layer | Thickness | Film #1 | Film #2 |
|---|---|---|---|
| Skin layer | 49 μm | PP Borealis RE216CF | Compound 1A |
| Tie layer | 5 μm | PP-MAH | PP-MAH |
| | | Admer QF300E | Admer QF300E |
| Barrier layer | 28 μm | PA Grilon FG4ONL | PA Grilon FG4ONL |
| | | nat6021 | nat6021 |
| Tie layer | 5 μm | PP-MAH | PP-MAH |
| | | Admer QF300E | Admer QF300E |
| Seal layer | 94 μm | 60% PP RE216CF | 60% Compound 1A |
| | | 25% sTPE XX | 25% sTPE XX |
| | | 15% LLDPE Stamylex | 15% LLDPE Stamylex |
| | | 1026F | 1026F |

Coefficient of friction results (according to a Baxter proprietary method):

### Skin/Skin:

Film #1: 0.48-0.52
Film #2: 0.48

### Seal/Seal:

Film #1: 0.61 - 0.65
Film #2: 0.60

RoI results in wt% (according to the Korean Pharmacopoeia method, 8^{th} version):
Film #1: 0.15%
Film #2: 0.06%

### Conclusion:

Film #2 having the microspheres had similar friction/slip properties as Film #1 without the microspheres while the RoI was reduced by a factor of 2.5.

### Example 2

A series of polypropylene films was prepared to demonstrate the effect of varying sizes and concentrations of microspheres on the coefficient of friction (CoF) and haze in the film. The matrix for each of films 1-9 was BORMED RD804CF, a medical film grade polypropylene random copolymer available from Borealis AG; the matrix for film 19 was Borealis RE216CF. The following table describes the films and the resulting coefficient of friction.

| | | Additive | Haze, % | Static | Dynamic |
|---|---|---|---|---|---|
| Film | Solid | conc. | (ASTM | CoF | CoF |
| ref. | Additive | (ppm) | D1003) | (ISO 8295) | (ISO 8295) |
| 1 | im30K | 0 | 4.5 | 1.62 | 1.26 |
| 2 | im30K | 200 | 4.8 | 0.86 | 0.93 |
| 3 | im30K | 300 | 6.4 | 0.79 | 0.83 |
| 4 | im30K | 400 | 5.6 | 0.77 | 0.82 |
| 5 | im30K | 500 | 4.2 | 0.81 | 0.86 |
| 6 | im30K | 1000 | 6.3 | 0.74 | 0.74 |
| 7 | im30K | 1500 | 10.8 | 0.75 | 0.76 |
| 8 | K46 | 500 | 4.1 | 0.95 | 1.04 |
| 9 | im30K/K46 | 500 | 4.7 | 0.85 | 0.92 |
| 19 | silica | 1800 | 3.7 | 0.69 | 0.66 |

These data reflect that a concentration of hollow microspheres provides acceptable haze and nearly equivalent reduction in coefficient of friction as does a much greater concentration of solid silica, together with an expected substantial decrease in residue on ignition resulting from the significantly reduced mass of additive.

### Example 3

Another series of polypropylene/polyethylene/thermoplastic elastomer films was prepared to demonstrate the effect of varying sizes and concentrations of microspheres on the coefficient of friction (CoF) in the film. The matrix for film 20 was a blend comprising 60% polypropylene random copolymer (Borealis RD804CF), 15% linear low density polyethylene (Stamylex 1026F), and 25% styrene-ethylene-butene-styrene block copolymer (SEBS). The matrix for each of films 10-18 was identical to the matrix of film 20 except that the polypropylene random copolymer was Borealis RE216CF. The following table describes the films and the resulting haze and coefficient of friction.

| | | Additive | Haze, % | Static | Dynamic |
|---|---|---|---|---|---|
| Film | Solid | conc. | (ASTM | CoF | CoF |
| ref. | Additive | (ppm) | D1003) | (ISO 8295) | (ISO 8295) |
| 10 | im30K | 0 | 27.5 | 1.59 | 1.21 |
| 11 | im30K | 200 | 27.9 | 1.22 | 1.04 |
| 12 | im30K | 300 | 25.8 | 1.13 | 1.01 |
| 13 | im30K | 400 | 27.8 | 1.01 | 0.91 |
| 14 | im30K | 500 | 28.2 | 0.93 | 0.83 |
| 15 | im30K | 1000 | 29.1 | 0.82 | 0.74 |
| 16 | im30K | 1500 | 29.8 | 0.81 | 0.7 |
| 17 | K46 | 500 | 27.5 | 1.01 | 0.9 |
| 18 | im30K/K46 | 500 | 27.3 | 0.64 | 0.61 |
| 20 | silica | 1800 | 34.4 | 1.14 | 0.97 |

These data reflect that a concentration of hollow microspheres provides acceptable haze and nearly equivalent reduction in coefficient of friction as does a much greater concentration of solid silica, together with an expected substantial decrease in residue on ignition as a result of the significantly reduced mass of material added.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A polymeric film comprising at least one layer having hollow microspheres mixed within the layer.

2. The film of claim 1, wherein the microspheres are present in a concentration ranging from about 250 ppm to about 3000 ppm within the layer.

3. The film of claim 1, wherein the layer having the microspheres further comprises silica mixed within the layer.

4. The film of claim 3, wherein the silica is present at a concentration ranging from about 1000 ppm to about 2000 ppm within the layer.

5. The film of claim 1, wherein the layer having the microspheres comprises a nanomaterial mixed within the layer.

6. The film of claim 1, wherein the microspheres comprise soda lime borosilicate glass.

7. The film of claim 1, wherein the microspheres have diameters ranging from about 10 μm to about 300 μm.

8. The film of claim 1, wherein the microspheres have a particle density ranging from about 0.1 g/cc to about 1.2 g/cc.

9. The film of claim 8, wherein the microspheres have a particle density ranging from about 0.1 g/cc to about 0.5 g/cc.

10. The film of claim 1, wherein the microspheres are distributed substantially uniformly throughout the layer.

11. The film of claim 1, wherein the microspheres are disposed in a surface layer of the film and are distributed nonuniformly such that the concentration of microspheres in a portion of the layer proximate to a surface of the film substantially exceeds the average concentration of microspheres in said layer.

12. The film of claim 11, wherein said surface layer comprises a plurality of sublayers, wherein said portion of the layer proximate to the film surface comprises at least one of said sublayers containing microspheres, and wherein at least another one of said sublayers is substantially free of microspheres.

13. A multi-layered film comprising a skin layer, a barrier layer and a seal layer, wherein the skin layer and the seal layer are attached to the core layer on opposing sides of the barrier layer and wherein at least one of the skin layer and the peel seal layer comprises hollow glass microspheres mixed within the layer.

14. The film of claim 13, wherein the microspheres are present in an amount sufficient to reduce the coefficient of friction of the film, as measured by ISO 8295, by at least 50%.

15. The film of claim 13, wherein the skin layer comprises a component selected from the group consisting of polypropylene random copolymers, polypropylene homopolymers, nylon, styrene-ethylene-butylene-styrene block copolymer, copolyester ether block copolymers, and combinations thereof.

16. The film of claim 13, wherein the seal layer comprises a material selected from the group consisting of a homophase polymer, a matrix-phase polymer and combinations thereof.

17. The film of claim 13, wherein the seal layer comprises a blend or alloy of a first polypropylene with a styrene-ethylene-butylene-styrene block copolymer, said first polypropylene having a first melting point.

18. The film of claim 17, wherein the seal layer further comprises a second polyolefin selected from the group consisting of polypropylene and polyethylene, said second polyolefin having a melting point different from said first melting point.

19. The film of claim 13, wherein the barrier layer comprises a component selected from the group consisting of polyamide 6, polyamide 6,6/polyamide 6,10 copolymer, amorphous polyamides, and combinations thereof.

20. The film of claim 13, wherein the barrier layer comprises an ethylene vinyl alcohol copolymer.

21. The film of claim 20, wherein the barrier layer further comprises two sublayers of a polyamide component disposed on opposite sides of a sublayer containing the ethylene vinyl alcohol copolymer.

22. The film of claim 13 further comprising at least one tie layer that attaches at least one of the skin layer and the seal layer to the barrier layer.

23. The film of claim 22, wherein the tie layer comprises a component selected from the group consisting of maleated linear low-density polyethylene, maleated polypropylene homopolymers, maleated polypropylene copolymers and combinations thereof.

24. The film of claim 13 further comprising a core layer positioned between the barrier layer and at least one of the skin layer and the seal layer.

25. The film of claim 24, wherein the core layer comprises a component selected from the group consisting of polypropylene homopolymers, propylene-ethylene random copolymers, polypropylene elastomers, propylene based elastomers, ethylene based elastomers, styrene-ethylene-butylene-styrene block copolymers, ethylene-propylene rubber modified polypropylenes and combinations thereof.

26. The film of claim 13, wherein the microspheres are present in a concentration ranging from about 250 ppm to about 3000 ppm within the layer.

27. The film of claim 13, wherein the layer having the microspheres further comprises silica mixed within the layer.

28. The film of claim 27, wherein the silica is present in a concentration ranging from about 1000 ppm to about 2000 ppm within the layer.

29. The film of claim 13, wherein the microspheres comprise soda lime borosilicate glass.

30. The film of claim 13, wherein the microspheres have a diameter ranging from about 10 μm to about 300 μm.

31. The film of claim 13, wherein the microspheres have a particle density ranging from about 0.1 g/cc to about 1.2 g/cc.

32. The film of claim 31, wherein the microspheres have a particle density ranging from about 0.1 g/cc to about 0.5 g/cc.

33. A multiple chamber container comprising:
a body defined by a film, the body including at least two chambers separated by a peelable seal, the film comprising at least one layer having microspheres mixed within the layer.

34. A container comprising a first sidewall and a second sidewall sealed together along at least one common peripheral edge to define a fluid chamber, wherein at least one of the first and second sidewall comprises a multilayer film comprising:
a skin layer;
a first tie layer;
a barrier layer disposed adjacent the first tie layer;
a second tie layer disposed adjacent the barrier layer;
a core layer; and
a seal layer, wherein at least one of the skin layer and the seal layer comprises glass microspheres mixed within the layer.

35. A method of making a film, the method comprising:
mixing hollow microspheres throughout a polymer;
extruding the polymer into a layer of a film.

36. The method of claim 35 further comprising forming a container out of the film.
